(19) United States
(12) Patent Application Publication
(10) Pub. No.: US 2016/0146538 A1
(43) Pub. Date: May 26, 2016

(54) GUARD DEVICE FOR PROTECTING THE BRICK RIM OF A BARREL KILN

(71) Applicant: Brick Saver Corporation, Carolina Beach, NC (US)

(72) Inventor: Roger Mansur, Carolina Beach, NC (US)

(73) Assignee: BRICK SAVER CORPORATION, Carolina Beach, NC (US)

(21) Appl. No.: 14/817,637

(22) Filed: Aug. 4, 2015

Related U.S. Application Data
(60) Provisional application No. 62/082,940, filed on Nov. 21, 2014.

(51) Int. Cl. F27D 1/00

(52) U.S. Cl. CPC F27D 1/00; F27D 2001/005

(57) ABSTRACT

A guard device for protecting the brick rim of a barrel kiln is disclosed. In some embodiments, the guard device is an elongated, thin, flat, rigid member that can be configured to substantially correspond to the geometry of the rim of the heating chamber of a barrel kiln.

### CROSS-REFERENCE TO RELATED APPLICATIONS

This application claims the benefit of U.S. Provisional Application No. 62/082,940, filed Nov. 21, 2014, which is incorporated herein by reference in its entirety.

### TECHNICAL FIELD

The presently disclosed subject matter relates generally to kilns used in ceramics or pottery and more particularly to a guard device for protecting the brick rim of a barrel kiln.

### BACKGROUND

Pottery is the ceramic act of making pottery wares, such as earthenware, stoneware, and porcelain. “Firing” is the process of baking ceramics in a kiln or furnace, which produces irreversible changes in the ceramic article. As a rough guide, earthenwares are normally fired at temperatures in the range of from about 1,000° C. to about 1,200° C.; stonewares at from about 1,100° C. to about 1,300° C.; and porcelains at from about 1,200° C. to about 1,400° C.

Firing pottery can be done using a variety of methods, with a kiln being the most common firing method. One type of kiln is a barrel kiln, an example of which is shown in FIG. 1. For example, FIG. 1 shows a side view and a plan view of a barrel kiln 100 that comprises a heating chamber 110 and a lid 115. The heating chamber 110 can be lined with a plurality of bricks (e.g., bricks 120). The heating chamber 110 can be, for example, an 8-sided (octagonal) chamber, a 10-sided (decagonal) chamber, or a 12-sided (dodecagonal) chamber. In the example shown in FIG. 1, the heating chamber 110 is a 10-sided chamber, meaning that 10 stacks of bricks 120 are arranged in substantially circular (or decagonal) fashion to form the walls of the heating chamber 110.

When the lid of a barrel kiln is open, the upper surfaces of the bricks are exposed, e.g., the surface of the bricks that is visible when looking down on the plan view of FIG. 1. When loading or unloading the barrel kiln, a person leans over the rim or edge of the heating chamber and makes contact with the exposed surfaces of the bricks. Because bricks are a relatively fragile article, the bricks are prone to breaking or damage due to, for example, the weight of the person leaning on the bricks, contact of the person to the bricks, and/or accidental contact of pottery articles to the bricks. Further, any contact with the exposed surfaces of the bricks may cause brick particles or dust to fall inside the heating chamber, causing defects in the finished pottery products.

### SUMMARY

In one aspect, the presently disclosed subject matter provides a guard device for protecting a brick rim of a barrel kiln, the device comprising a plurality of segments arranged end to end and at an angle a, wherein each segment has a length, L, a width, w, and a thickness, t, and wherein the length of each segment substantially corresponds to a length of a brick comprising the brick rim of the barrel kiln, the width substantially corresponds to a width of a brick comprising the brick rim of the barrel kiln, and the angle α substantially corresponds to an angle of a geometry of the brick rim of the barrel kiln.

Certain aspects of the presently disclosed subject matter having been stated hereinabove, which are addressed in whole or in part by the presently disclosed subject matter, other aspects will become evident as the description proceeds when taken in connection with the accompanying Examples and Drawings as best described herein below.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a side view and a plan view of an example of a conventional barrel kiln;

FIG. 2 illustrates a perspective view of an example of the presently disclosed guard device for protecting the brick rim of a barrel kiln;

FIG. 3 illustrates other views showing more details of the presently disclosed guard device for protecting the brick rim of a barrel kiln;

FIG. 4 illustrates a perspective view of the presently disclosed guard device comprising a backing material;

FIG. 5 and FIG. 6 illustrate plan views of examples of the presently disclosed guard device in relation to the brick rim of a barrel kiln; and

FIG. 7 illustrates a flow diagram of an example of a method of using the presently disclosed guard device for protecting the brick rim of a barrel kiln.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

### I. Guard Device for Protecting the Brick Rim of a Barrel Kiln

In some embodiments, the presently disclosed subject matter provides a guard device for protecting the brick rim of a barrel kiln. Namely, the presently disclosed guard device is an elongated, thin, flat, rigid member that can be configured to substantially correspond to a geometry of the rim of the heating chamber of a barrel kiln. The presently disclosed guard device is designed to lay atop the rim of the heating chamber of a barrel kiln and thereby provide a protective barrier atop the bricks against accidental impacts or normal wear and tear. Further, the guard device helps distribute the weight of a person who is leaning over the rim of the open heating chamber when loading and unloading the barrel kiln. In some embodiments, a backing material or layer is provided on the guard device to assist the guard device with griping or adhering to the upper surface of the bricks. In other embodiments, the guard device may include tabs, clips, lips, or any other mechanisms for securing the guard device to the rim of the heating chamber of a barrel kiln.

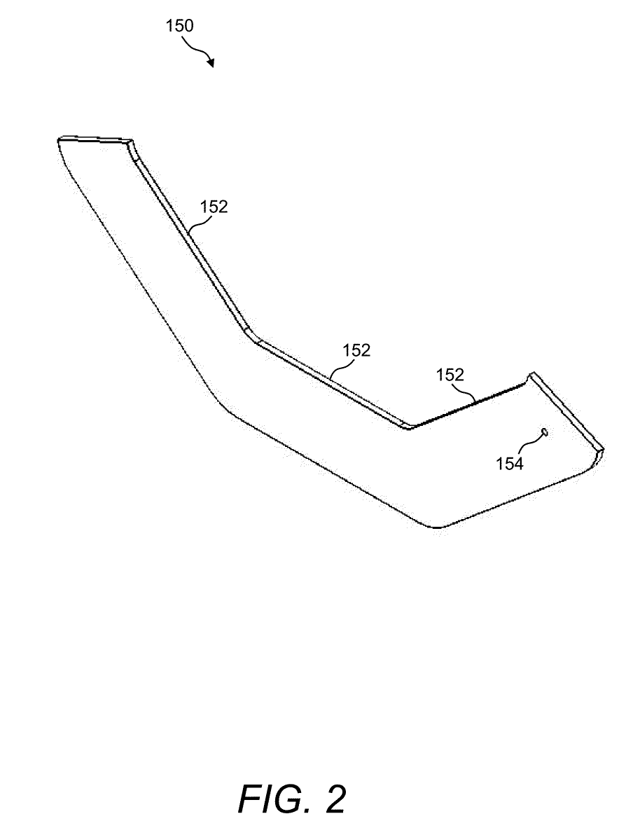

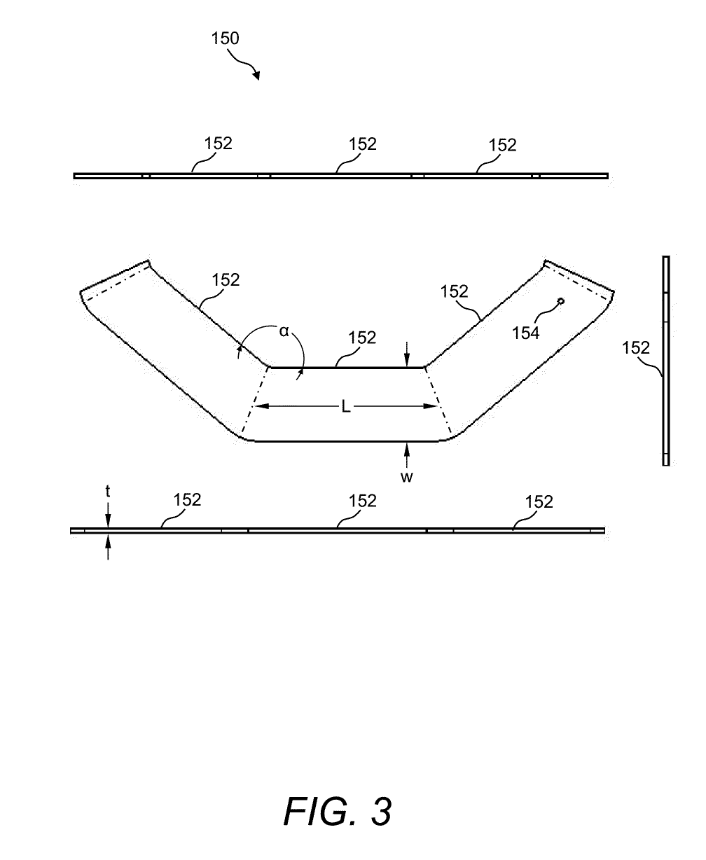

Referring now to FIG. 2 is a perspective view of an example of the presently disclosed guard device 150 for protecting the brick rim of a barrel kiln. Further, FIG. 3 shows other detailed views of guard device 150. Guard device 150 is an elongated, thin, flat, rigid member that can be configured to substantially correspond to the geometry of the rim of the heating chamber of a barrel kiln. Guard device 150 is designed to lay atop the rim of the heating chamber of a barrel kiln and thereby provide a protective barrier atop the bricks against accidental impacts. Further, guard device 150 helps distribute the weight of a person leaning over the rim of the open heating chamber when loading and unloading the barrel kiln.

Namely, guard device 150 is an elongated, thin, flat, rigid member that comprises a plurality of segments 152 that are arranged end-to-end and at an angle α. Each segment 152 has a length L and a width w. Further, each segment of guard device 150 has a thickness t. Thickness t of each segment 152 can be the same or different. The segments 152 of the guard device 150 substantially correspond to the respective sides of a barrel kiln. Accordingly, in particular embodiments, the length of each segment substantially corresponds to a length of a brick comprising the brick rim of the barrel kiln, the width substantially corresponds to a width of a brick comprising the brick rim of the barrel kiln, and the angle α substantially corresponds to an angle of a geometry of the brick rim of the barrel kiln.

Accordingly, the number of segments 152, the angle α between of segments 152, the length L of segments 152, and the width w of segments 152 can vary depending on the geometry of the barrel kiln with which it is used. For example, for an 8-sided barrel kiln, the segments 152 have a certain length L, a certain width w, and a certain angle α. For a 10-sided barrel kiln, the segments 152 have a different length L, a different width w, and a different angle α. For a 12-sided barrel kiln, the segments 152 have still a different length L, a different width w, and a different angle α.

Further, guard device 150 can be designed to protect the entirety of the rim of the heating chamber of a barrel kiln or any portion thereof. For example, for an 8-sided barrel kiln, guard device 150 can have from one to eight segments 152 and any portions thereof for a 10-sided barrel kiln, guard device 150 can have from one to ten segments 152 and any portions thereof and for a 12-sided barrel kiln, guard device 150 can have from one to twelve segments 152 and any portions thereof.

In the example shown in FIG. 2 and FIG. 3, the guard device 150 has three segments 152, which, in other embodiments, guard device 150 has two segments. In one example, the length L can range from about 7 inches to about 9.3 inches, the width w can range from about 1.5 inches (38.1 mm) to about 5 inches (127 mm), the angle α can range from about 140 degrees to about 155 degrees, and the thickness t can range from about 0.03 inches (0.762 mm) to about 3 inches (76.2 mm). The inside and outside corners in the footprint of the guard device 150 can be rounded or not rounded. Further, the edges of the guard device 150 can be rounded or not rounded.

Further, a through-hole 154 can be provided in one or both ends of guard device 150. Using the through-hole 154, the guard device 150 can be conveniently hung, for example, on the wall for easy storage.

The guard device 150 can be a solid structure or a multilayer structure. The guard device 150 can be formed of any rigid or semi-rigid material, such as, but not limited to, wood, wood composite, any composite or laminate material, fabricated or molded thermoplastic or thermoset material, fiberglass, metal (e.g., aluminum, steel), sheeting material used in sign making, and the like.

In one example of a method of making the guard device 150, multiple guard devices 150 are machined out of a single large sheet of sheeting material used for sign-making This sign-making material may be, for example, a multilayer sheet consisting of a high-density polyethylene (HDPE) layer sandwiched between two layers of aluminum. The total thickness of the sign-making material can be, for example, about 3 mm (0.12 inches), about 6 mm (0.24 inches), or about 9 mm (0.35 inches).

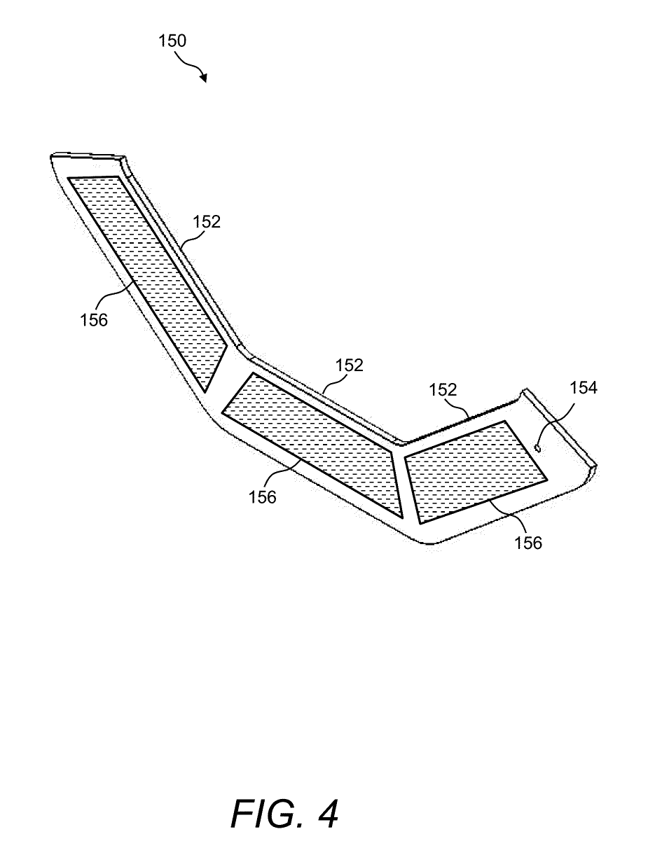

Referring now to FIG. 4, in some embodiments, a backing material or layer 156 is provided on one side of guard device 150, wherein the backing material or layer 156 is used to assist the guard device 150 with griping the bricks. In one example, the backing material or layer 156 is a layer of felt that can be adhered to the surface of the guard device 150. In this example, the felt can be provided in multiple segments or patches or can be one continuous piece of material. In another example, the backing material or layer 156 can be a coating, such as the spray-on protective coatings (e.g., polymers) used for truck bed protection. An example is the spray-on protective coatings available from LINE-X (Huntsville, Ala.).

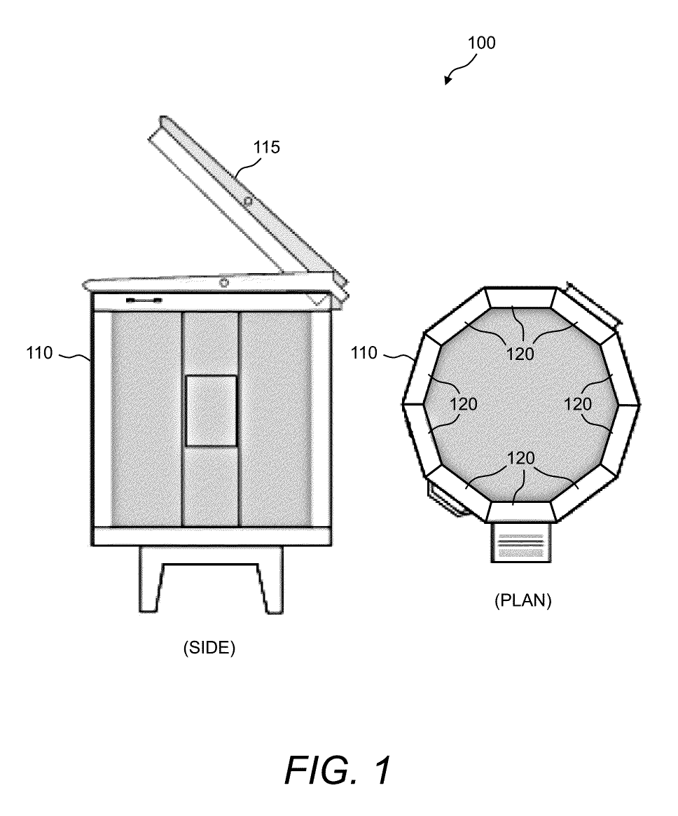

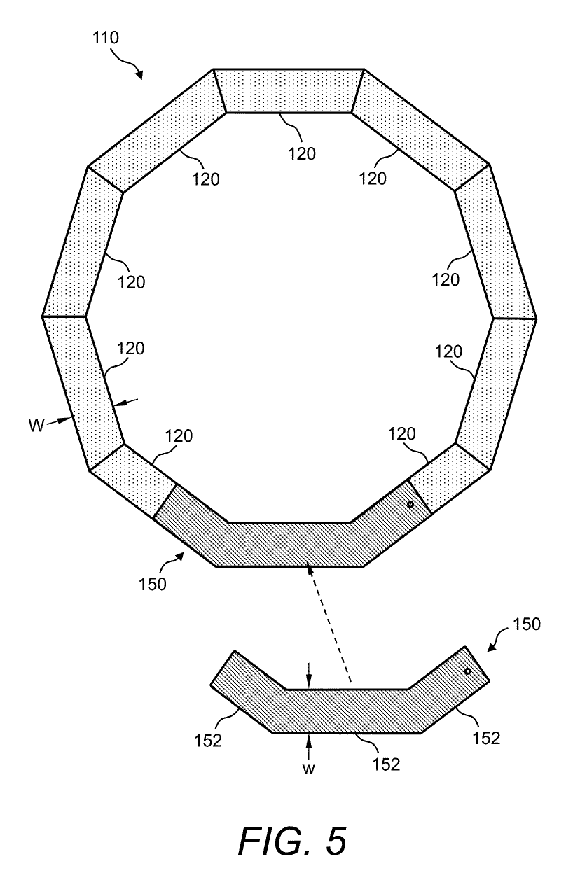

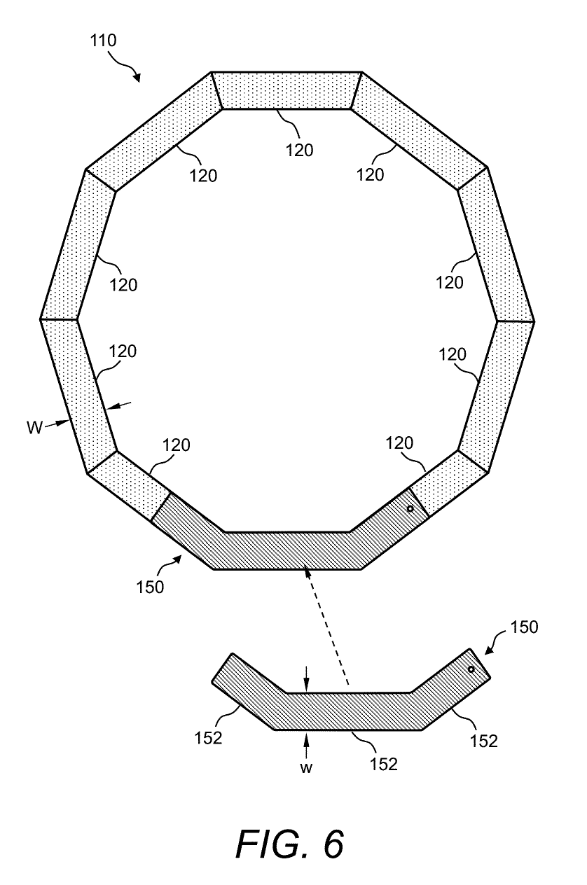

Referring now to FIG. 5 and FIG. 6 are plan views of examples of the presently disclosed guard device 150 in relation to the brick rim of a barrel kiln, such as the barrel kiln 100 shown in FIG. 1. Namely, FIG. 5 shows a top down view of the heating chamber 110 of the 10-sided barrel kiln 100. In this example, the bricks 120 have a width W of about 3 inches, accordingly, the width w of the guard device 150 also is about 3 inches. In the example shown in FIG. 5, the guard device 150 comprises one full segment 152 arranged between two partial segments 152. Similarly, FIG. 6 shows a top down view of the heating chamber 110 of the 10-sided barrel kiln 100. In this example, the bricks 120 have a width W of about 2.5 inches, accordingly, the width w of the guard device 150 is also about 2.5 inches. Again, the guard device 150 comprises one full segment 152 arranged between two partial segments 152.

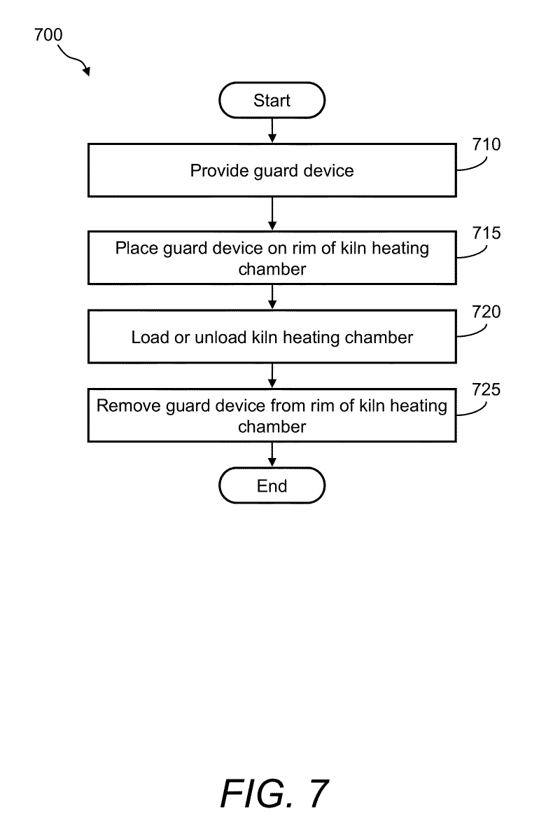

Referring now to FIG. 7 is a flow diagram of an example of a method 700 of using the presently disclosed guard device 150 for protecting the brick rim of a barrel kiln, such as the barrel kiln 100 shown in FIG. 1. The method 700 may include, but is not limited to, the following steps.

At a step 710, the guard device 150 is provided, wherein the configuration of the guard device 150 substantially corresponds to the geometry of the rim of the heating chamber of a barrel kiln. In one example, for an 8-sided barrel kiln, a guard device 150 is provided that is configured to substantially correspond to the geometry of the rim of the 8-sided barrel kiln. In another example, for a 10-sided barrel kiln, a guard device 150 is provided that is configured to substantially correspond to the geometry of the rim of the 10-sided barrel kiln. In yet another example, for a 12-sided barrel kiln, a guard device 150 is provided that is configured to substantially correspond to the geometry of the rim of the 12-sided barrel kiln.

At a step 715, the guard device 150 is placed on the rim of the kiln heating chamber. For example, the guard device 150 is placed on the rim of the heating chamber 110 of the barrel kiln 100, as shown in FIG. 5 and FIG. 6. Namely, the side of the guard device 150 that has the backing material or layer 156 is placed on the bricks 120.

At a step 720, the heating chamber of the barrel kiln is loaded or unloaded. For example, a person leans over the rim of the heating chamber 110 of the barrel kiln 100 and loads or unloads the heating chamber 110 of pottery items. All the while, the guard device 150 is distributing the weight of the person across the area of the guard device 150 and thereby preventing brick breakage. Further, the guard device 150 is protecting the surface of the bricks 120 from the person's contact as well as from accidental contact of the pottery items, thereby preventing damage to the surface of the bricks 120. In so doing, the guard device 150 prevents brick particles or dust from falling inside the heating chamber 110 and contaminating the environment.

At a step 725, the guard device 150 is removed from the rim of the kiln heating chamber. For example, the guard device 150 is removed from the rim of the heating chamber 110 of the barrel kiln 100. Subsequently, using the through-hole 154, the guard device 150 can be hung on the wall for easy storage.

The guard device 150 is not limited to the examples shown hereinabove with reference to FIG. 2 through FIG. 7. In other embodiments, the guard device 150 may include tabs, clips, lips, or any other mechanisms for securing the guard device 150 to the rim of the heating chamber of the barrel kiln. Further, instead of being a flat member, the guard device 150 can comprise an L-channel or U-channel member, wherein the L-channel or U-channel member is sized to be fitted onto and/or over the rim of the heating chamber of the barrel kiln.

Further, to avoid the guard device 150 being inadvertently left atop the heating chamber after loading, the guard device 150 may have a finished (e.g., painted) surface so that it has a contrasting look to the rim of the heating chamber of the barrel kiln. In other words, the guard device 150 may have a finished surface that is easily noticed by the user.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A guard device for protecting a brick rim of a barrel kiln, the device comprising a plurality of segments arranged end to end and at an angle a, wherein each segment has a length, L, a width, w, and a thickness, t, and wherein the length of each segment substantially corresponds to a length of a brick comprising the brick rim of the barrel kiln, the width substantially corresponds to a width of a brick comprising the brick rim of the barrel kiln, and the angle α substantially corresponds to an angle of a geometry of the brick rim of the barrel kiln.

2. The guard device of claim 1, wherein the length has a range from about 7 inches to about 9.3 inches.

3. The guard device of claim 1, wherein the width has a range from about 1.5 inches to about 5 inches.

4. The guard device of claim 1, wherein the angle α has a range from about 140 degrees to about 155 degrees.

5. The guard device of claim 1, wherein the thickness has a range from about 0.03 inches to about 3 inches.

6. The guard device of claim 1, wherein the guard device is fabricated from a material selected from the group consisting of a wood, a wood composite, a composite or laminate material, fabricated or molded thermoplastic or thermoset material, fiberglass, a metal, and a sheeting material used in sign making.

7. The guard device of claim 6, wherein the sheeting material used in sign making comprise a multilayer composite comprising a high-density polyethylene layer sandwiched between two layers of aluminum.

8. The guard device of claim 1, further comprising a backing material.

9. The guard device of claim 8, wherein the backing material comprises a material selected from the group consisting of felt and a spray-on protective polymer coating.

10. The guard device of claim 1, further comprising a through-hole proximate at least one end of the guard device.

11. The guard device of claim 1, wherein the barrel kiln is selected from the group consisting of an 8-sided barrel kiln, a 10-sided barrel kiln, and a 12-sided barrel kiln.

12. The guard device of claim 1, wherein the guard device has at least two segments.
